(19) United States
(12) Patent Application Publication
(10) Pub. No.: US 2020/0106828 A1
(43) Pub. Date: Apr. 2, 2020

(54) Parallel Computation Network Device

(71) Applicant: MELLANOX TECHNOLOGIES, LTD., Yokneam (IL)

(72) Inventors: George Elias, Tel Aviv (IL); Lion Levi, Yavne (IL); Evyatar Romlet, Raanana (IL); Amiad Marelli, Herzliya (IL)

(21) Appl. No.: 16/357,356

(22) Filed: Mar. 19, 2019

Related U.S. Application Data
(60) Provisional application No. 62/739,879, filed on Oct. 2, 2018.

(51) Int. Cl. H04L 29/08; G06F 9/50; G06F 9/38; H04L 12/935; H04L 29/06

(52) U.S. Cl. CPC H04L 67/10; G06F 9/5072; H04L 69/22; H04L 49/30; G06F 9/3885

(57) ABSTRACT

In one embodiment, a network device includes ports to serve as ingress ports and as egress ports, streaming aggregation circuitry to analyze received data packets to identify the data packets having payloads targeted for a data reduction process as part of an aggregation protocol, parse at least some of the identified data packets into payload data and headers, and inject the parsed payload data into the data reduction process, data reduction circuitry to perform the data reduction process, and including hardware data modifiers (HDMs), the HDMs being connected and arranged to reduce the parsed payload data in stages with a stage of the data reduction process being performed by a central HDM to receive data from at least two non-central HDMs and to output resultant reduced data, and a transport layer controller to manage forwarding of the resultant reduced data to at least one network node.

### RELATED APPLICATION INFORMATION

The present application claims priority from U.S. Provisional Patent Application Ser. No. 62/739,879 of Levi, et al., filed Oct. 2, 2018, the disclosure of which is hereby incorporated herein by reference.

### FIELD OF THE INVENTION

The present invention relates to parallel computation, and in particular, but not exclusively, to parallel computation in a network device.

### BACKGROUND

In general, a task in parallel computation may require performing a reduction operation on a stream of data which is distributed over several nodes in a network. An example of a reduction operation may be a floating point ADD operation. The result of the operation may be published to one or more requesting processors. Another example of a reduction operation may include computing a variance of a large amount of data. The data may be distributed over N sub-processes, over N respective nodes, where each sub-process holds a subset of the data. Each sub-process calculates the sum (referred to as a first order sum below) of its data subset and calls a sum reduction operation. In a similar manner, the sum of each element to the power of two (e.g., squared) (referred to as a second order sum below) may be computed. The resulting first and second order sums are distributed to the N sub-processes. Each of the N sub-processes then computes the variance based on the first and second order sums of all the data subsets. Computing the variance by each of the N sub-processes may be useful, for example, when an application on one of the N nodes searches for some sort of estimator. In some cases, for each given estimator, the average and variance of an error may be computed, and according to the results, each of the N sub-processes selects a new estimator. Since the code in all the sub-processes is the same, the new estimator will be the same as well.

Modern computing and storage infrastructure use distributed systems to increase scalability and performance. Common uses for such distributed systems include: datacenter applications, distributed storage systems, and HPC clusters running parallel applications. While HPC and datacenter applications use different methods to implement distributed systems, both perform parallel computation on a large number of networked compute nodes with aggregation of partial results or from the nodes into a global result.

Many datacenter applications such as search and query processing, deep learning, graph and stream processing typically follow a partition-aggregation pattern. An example is the well-known MapReduce programming model for processing problems in parallel across huge datasets using a large number of computers arranged in a grid or cluster. In the partition phase, tasks and data sets are partitioned across compute nodes that process data locally potentially taking advantage of locality of data to generate partial results. The partition phase is followed by the aggregation phase where the partial results are collected and aggregated to obtain a final result. The data aggregation phase in many cases creates a bottleneck on the network due to many-to-one or many-to-few types of traffic, i.e., many nodes communicating with one node or a few nodes or controllers.

For example, in large public datacenters analysis traces show that up to 46% of the datacenter traffic is generated during the aggregation phase, and network time can account for more than 30% of transaction execution time. In some cases, network time accounts for more than 70% of the execution time.

Collective communication is a term used to describe communication patterns in which all members of a group of communication end-points participate. For example, in case of Message Passing interface (MPI) the communication end-points are MPI processes and the groups associated with the collective operation are described by the local and remote groups associated with the MPI communicator.

Many types of collective operations occur in HPC communication protocols, and more specifically in MPI and SHMEM (OpenSHMEM). The MPI standard defines blocking and non-blocking forms of barrier synchronization, broadcast, gather, scatter, gather-to-all, all-to-all gather/scatter, reduction, reduce-scatter, and scan. A single operation type, such as gather, may have several different variants, such as scatter and scatterv, which differ in such things as the relative amount of data each end-point receives or the MPI data-type associated with data of each MPI rank, i.e., the sequential number of the processes within a job or group.

The OpenSHMEM specification (available on the Internet from the OpenSHMEM website) contains a communications library that uses one-sided communication and utilizes a partitioned global address space. The library includes such operations as blocking barrier synchronization, broadcast, collect, and reduction forms of collective operations.

The performance of collective operations for applications that use such functions is often critical to the overall performance of these applications, as they limit performance and scalability. This comes about because all communication end-points implicitly interact with each other with serialized data exchange taking place between end-points. The specific communication and computation details of such operations depend on the type of collective operation, as does the scaling of these algorithms. Additionally, the explicit coupling between communication end-points tends to magnify the effects of system noise on the parallel applications using these, by delaying one or more data exchanges, resulting in further challenges to application scalability.

Previous attempts to mitigate the traffic bottleneck include installing faster networks and implementing congestion control mechanisms. Other optimizations have focused on changes at the nodes or endpoints, e.g., HCA enhancements and host-based software changes. While these schemes enable more efficient and faster execution, they do not reduce the amount of data transferred and thus are limited.

US Patent Publication 2017/0063613 of Bloch, et al. (hereinafter the '613 publication), which is hereby incorporated herein by reference, describes a scalable hierarchical aggregation protocol that implements in-network hierarchical aggregation, in which aggregation nodes (switches and routers) residing in the network fabric perform hierarchical aggregation to efficiently aggregate data from a large number of servers, without traversing the network multiple times. The protocol avoids congestion caused by incast, when many nodes send data to a single node.

The '613 publication describes an efficient hardware implementation integrated into logic circuits of network switches, thus providing high performance and efficiency. The protocol advantageously employs reliable transport such as RoCE and lnfiniBand transport (or any other transport assuring reliable transmission of packets) to support aggregation. The implementation of the aggregation protocol is network topology-agnostic, and produces repeatable results for non-commutative operations, e.g., floating point ADD operations, regardless of the request order of arrival. Aggregation result delivery is efficient and reliable, and group creation is supported.

The '613 publication describes modifications in switch hardware and software. The protocol can be efficiently realized by incorporating an aggregation unit and floating point ALU into a network switch ASIC. The changes improve the performance of selected collective operations by processing the data as it traverses the network, eliminating the need to send data multiple times between end-points. This decreases the amount of data traversing the network as aggregation nodes are reached. In one aspect of the '613 publication collective communication algorithms are implemented in the network, thereby freeing up CPU resources for computation, rather than using them to process communication.

The modified switches of the '613 publication support performance-critical barrier and collective operations involving reduction of data sets, for example reduction in the number of columns of a table. The modifications in the switches enable the development of collective protocols for frequently-used types of collective operations, while avoiding a large increase in switch hardware resources, e.g., die size. For a given application-to-system mapping, the reduction operations are reproducible, and support all but the product reduction operation applied to vectors, and also support data types commonly used by MPI and OpenSHMEM applications. Multiple applications sharing common network resources are supported, optionally employing caching mechanisms of management objects. As a further optimization, hardware multicast may distribute the results, with a reliability protocol to handle dropped multicast packets. In a practical system, based on Mellanox Switch-1B2 lnfiniBand switches connecting 10,000 end nodes in a three-level fat-tree topology, the network portion of a reduction operation can be completed in less than three microseconds.

The '613 publication describes a mechanism, referred to as the “Scalable Hierarchical Aggregation Protocol” (SHArP), that performs aggregation in a data network efficiently. This mechanism reduces bandwidth consumption and reduces latency.

### SUMMARY

There is provided in accordance with an embodiment of the present disclosure, a network device, including a plurality of ports configured to serve as ingress ports for receiving data packets from a network and as egress ports for forwarding at least some of the data packets, streaming aggregation circuitry connected to the ingress ports, and configured to analyze the received data packets to identify ones of the data packets having payloads targeted for a data reduction process, parse at least some of the identified data packets into payload data and headers, and inject the parsed payload data into the data reduction process, data reduction circuitry connected to the ingress ports and configured to perform the data reduction process on the parsed payload data, and including a multiplicity of hardware data modifiers (HMDs) including a central HDM and non-central HDMs, the HDMs being connected and arranged to reduce the parsed payload data in stages with a stage of the data reduction process in the network device being performed by the central HDM which is configured to receive data from at least two of the non-central HDMs and to output resultant reduced data, and a transport layer controller configured to manage forwarding of the resultant reduced data in data packets to at least one network node via at least one of the egress ports.

Further in accordance with an embodiment of the present disclosure at least some of the HDMs are arranged in a hierarchical configuration including a root level, a leaf level and at one intermediate level, each one of the non-central HDMs in the leaf level is configured to receive data from at least two of the ingress ports and to output data to one of the non-central HDMs in the at least one intermediate level, and the central HDM is disposed in the root level, and is configured to receive data from the at least two non-central HDMs in the at least one intermediate level.

Still further in accordance with an embodiment of the present disclosure the HDMs are arranged in a daisy-chain configuration including at least two end nodes converging via intermediates nodes on a central node, wherein each one of the at least two end nodes includes one of the non-central HDMs configured to receive data from at least one of the ingress ports and to output data to one of the non-central HDMs disposed in one of the intermediate nodes, each one of the intermediate nodes includes one of the non-central HDMs configured to receive data from at least one of the ingress ports and one of the non-central HDMs, and the central node includes the central HDM which is configured to receive data from the at least two non-central HDMs of the intermediate nodes.

Additionally, in accordance with an embodiment of the present disclosure, the device includes a central block including the central HDM, an application layer controller configured to control at least part of an aggregation protocol among network nodes in the network, select the at least one network node to which to forward the resultant reduced data output by the central HDM, and manage operations performed by the HDMs, the transport layer controller which is also configured to perform requester handling of the data packets including the resultant reduced data, and a requester handling database to store data used in the requester handling.

Moreover, in accordance with an embodiment of the present disclosure, the device includes two respective input channels into the central block to the central HDM from two respective ones of the non-central HDMs, the non-central HDMs being disposed externally to the central block.

Further in accordance with an embodiment of the present disclosure the streaming aggregation circuitry is configured to perform responder handling, so as to split the responder handling and the requester handling of data packets of targeted for the data reduction process of the aggregation protocol between the streaming aggregation circuitry and the central block, respectively, each of the ingress ports further including a responder handling database to store data used in the responder handling.

Still further in accordance with an embodiment of the present disclosure at least some of the HDMs are arranged in a hierarchical configuration including a root level, a leaf level and at one intermediate level, each one of the non-central HDMs in the leaf level is configured to receive data from at least two of the ingress ports and to output data to one of the non-central HDMs in the at least one intermediate level, and the central HDM is disposed in the root level, and is configured to receive data from the at least two non-central HDMs in the at least one intermediate level.

Additionally, in accordance with an embodiment of the present disclosure the HDMs are arranged in a daisy-chain configuration including at least two end nodes converging via intermediates nodes on a central node, wherein each one of the at least two end nodes includes one of the non-central HDMs configured to receive data from at least one of the ingress ports and to output data to one of the non-central HDMs disposed in one of the intermediate nodes, each one of the intermediate nodes includes one of the non-central HDMs configured to receive data from at least one of the ingress ports and one of the non-central HDMs, and the central node includes the central HDM which is configured to receive data from the at least two non-central HDMs of the intermediate nodes.

Moreover, in accordance with an embodiment of the present disclosure the streaming aggregation circuitry includes a plurality of respective streaming aggregation circuitry units connected to, and serving respective ones of the ingress ports.

Further in accordance with an embodiment of the present disclosure the data reduction process is part of an aggregation protocol.

There is also provided in accordance with another embodiment of the present disclosure, a data reduction method, including receiving data packets in a network device from a network, forwarding at least some of the data packets, analyzing the received data packets to identify ones of the data packets having payloads targeted for a data reduction, parsing at least some of the identified data packets into payload data and headers, injecting the parsed payload data into the data reduction process, performing the data reduction process on the parsed payload data using data reduction circuitry including a multiplicity of hardware data modifiers (HDMs) including a central HDM and non-central HDMs, the HDMs being connected and arranged to reduce the parsed payload data in stages with a stage of the data reduction process in the network device being performed by the central HDM outputting resultant reduced data, and managing forwarding of the resultant reduced data in data packets to at least one network node.

Still further in accordance with an embodiment of the present disclosure at least some of the HDMs are arranged in a hierarchical configuration including a root level, a leaf level and at one intermediate level, the method further including receiving data from at least two ingress ports and outputting data to one of the non-central HDMs in the at least one intermediate level by one of the non-central HDMs in the leaf level, and receiving data from at least two non-central HDMs in the at least one intermediate level by the central HDM which is disposed in the root level.

Additionally, in accordance with an embodiment of the present disclosure the HDMs are arranged in a daisy-chain configuration including at least two end nodes converging via intermediates nodes on a central node, the method further including receiving data from at least one ingress port and outputting data to one of the non-central HDMs disposed in one of the intermediate nodes by one of non-central HDMs disposed in one of the at least two end nodes, receiving data from at least one ingress port and from one of the non-central HDMs by one of the non-central HDMs disposed in one of the intermediate nodes, and receiving data from at least two of the non-central HDMs of the intermediate nodes by the central HDM disposed in the central node.

Moreover, in accordance with an embodiment of the present disclosure, the method includes controlling at least part of an aggregation protocol among network nodes in the network, selecting the at least one network node to which to forward the resultant reduced data output by the central HDM, managing operations performed by the HDMs, performing requester handling of the data packets including the resultant reduced data, and storing data used in the requester handling.

Further in accordance with an embodiment of the present disclosure, the method includes performing responder handling by streaming aggregation circuitry, so as to split the responder handling and the requester handling of data packets targeted for the data reduction process of the aggregation protocol between the streaming aggregation circuitry and a central block including the central HDM, respectively, and storing data used in the responder handling.

Still further in accordance with an embodiment of the present disclosure at least some of the HDMs are arranged in a hierarchical configuration including a root level, a leaf level and at one intermediate level, the method further including receiving data from at least two ingress ports and outputting data to one of the non-central HDMs in the at least one intermediate level by one of the non-central HDMs in the leaf level, and receiving data from at least two non-central HDMs in the at least one intermediate level by the central HDM which is disposed in the root level.

Additionally, in accordance with an embodiment of the present disclosure the HDMs are arranged in a daisy-chain configuration including at least two end nodes converging via intermediates nodes on a central node, the method further including receiving data from at least one ingress port and outputting data to one of the non-central HDMs disposed in one of the intermediate nodes by one of non-central HDMs disposed in one of the at least two end nodes, receiving data from at least one ingress port and from one of the non-central HDMs by one of the non-central HDMs disposed in one of the intermediate nodes, and receiving data from at least two of the non-central HDMs of the intermediate nodes by the central HDM disposed in the central node.

Moreover, in accordance with an embodiment of the present disclosure the data reduction process is part of an aggregation protocol.

### BRIEF DESCRIPTION OF THE DRAWINGS

The present invention will be understood from the following detailed description, taken in conjunction with the drawings in which:

FIGS. 1 and 2 are block diagram views of network devices implementing data reduction;

FIG. 3 is a block diagram view of a network device implementing a data reduction process constructed and operative in accordance with an embodiment of the present invention;

FIG. 4 is a flowchart including exemplary steps in a method of operation of the network device of FIG. 3; and

FIG. 5 is a block diagram view of a network device implementing a data reduction process constructed and operative in accordance with an alternative embodiment of the present invention.

### DESCRIPTION OF EXAMPLE EMBODIMENTS

### Overview

As previously mentioned, a task in parallel computation may require performing a reduction operation on a stream of data which is distributed over several nodes in a network. In any node, a data reduction operation may be performed on a sub-set of the data and a result of the data reduction operation may then be distributed to one or more network nodes. The distribution of the data and the results may be managed in accordance with an aggregation protocol, for example, but not limited to, the “Scalable Hierarchical Aggregation Protocol” (SHArP), described in the abovementioned '613 publication.

The data reduction operation may be performed by any suitable processing device, for example, but not limited to, a network device such a switch or a router, which in addition to performing packet forwarding also performs data reduction. The network device may receive data packets from various respective network nodes over respective ingress ports. The received data packets may be analyzed to determine whether the packets should be forwarded to other network nodes, or whether the packets should be forwarded to a data reduction process within the receiving network device.

One problem to be addressed when performing data reduction in a network device is to perform the data reduction efficiently while maintaining throughput. Maintaining a high data throughput is particularly challenging when data is being received from multiple network nodes.

One solution is for the network device to include a central block to which all the packets destined for the data reduction process are sent. The central block may include a single arithmetic logic unit (ALU) to perform the data reduction process, an application layer controller to manage the aggregation protocol, and a transport layer controller to manage receiving data packets of the aggregation protocol and forwarding the resultant reduced data output of the data reduction process to one or more network nodes and to manage responder and requester handling. With this solution, the single ALU generally becomes quickly overloaded and cannot reduce the data arriving at more than two ingress ports without compromising throughput. Even if more ALUs are added to the central block the ingress and egress interface of the central block will become congested.

Another solution is to provide high speed links between each ingress port and the central block or multiple high speed links from forwarding circuitry to the central block with the central block including multiple ALUs arranged in a hierarchical structure so that in a first level of the hierarchical structure, data from any two ingress ports is reduced by one ALU, and in a second level the data output of the ALUs in the first level is reduced by the ALUs in the second level and so on until a central ALU receives data input from two ALUs to yield a final reduced data output. Therefore, the overall processing over the various ALUs takes place at a speed which is intended not to be limited other than by the maximum interconnect speed between the ALUs; this maximum speed is also termed herein “wire speed” (WS). Although, this solution provides sufficient throughput due to the different levels of ALUs, this solution requires high-speed connections running over the chip between each ingress port (or the forwarding circuitry) and the central block. This solution is generally not scalable because when the number of ports is increased, the high-speed connections running over the chip to the central block and the additional ALUs needed in the central block are increased, leading to a more complicated and expensive chip design and manufacture.

Therefore, in some embodiments of the present invention, the network device includes multiple non-central ALUs located outside of the central block on the same chip as the central block with generally two high speed connections from the non-central ALUs outside of the central block leading into a central ALU located in the central block. This design reduces the number of high-speed connections entering the central block from the device ports to two. Additionally, locating the non-central ALUs outside the central block generally leads to an overall shorter length of high-speed connections on the chip. The closer the non-central ALUs are to the ports generally leads to a shorter overall length of high-speed connections.

In some embodiments, the responder handling and requester handling of data packets associated with the data reduction process of the aggregation protocol are split between the streaming aggregation circuitry units associated with ingress ports (described in more detail below) and the transport later controller of the central block, respectively. Each of the ingress ports is associated with a responder handling database to store data associated with the responder handling, while the central block includes a requester handling database to store data associated with the requester handling.

As a result of splitting the responder handling and requester handling between the streaming aggregation circuitry units and the transport layer controller of the central block, the payload data of packets targeted for the data reduction process can be injection into the data reduction process without having to send all the packet data (e.g., including headers and other responder handling data) to the central block thereby reducing congestion in the central block.

Each of the ingress ports may be associated with a streaming aggregation circuitry unit which speculatively analyzes received data packets based on header data (described in more detail below) to identify the data packets having payloads targeted for the data reduction process as part of an aggregation protocol. The streaming aggregation circuitry unit, after receiving confirmation of the speculative analysis from the forwarding circuitry, parses the identified data packets into payload data and headers and injects the parsed payload data into the data reduction process.

In some embodiments the ALUs are arranged in a hierarchical configuration including a root level, a leaf level and one or more intermediate levels. Each non-central ALU in the leaf level may receive data from at least two of the ingress ports and output data to one of the non-central ALUs in an intermediate level adjacent to the leaf level. The central ALU is disposed in the root level, and receives data from two (or more) non-central ALUs in the intermediate level below the root level.

In other embodiments, the ALUs are arranged in a daisy-chain configuration comprising two (or more) end nodes converging via intermediates nodes on a central node. Each of the end nodes includes one of the non-central ALUs and may receive data from at least one ingress port and output data to a non-central ALU (i.e., the next ALU in the chain) disposed in one of the intermediate nodes. Each intermediate node includes a non-central ALU which may receive data from at least one ingress port and one of the non-central ALUs (i.e., the previous ALU in the chain). The central node includes the central ALU which receives data from two (or more) non-central ALUs of the intermediate nodes.

### System Description

Documents incorporated by reference herein are to be considered an integral part of the application except that, to the extent that any terms are defined in these incorporated documents in a manner that conflicts with definitions made explicitly or implicitly in the present specification, only the definitions in the present specification should be considered.

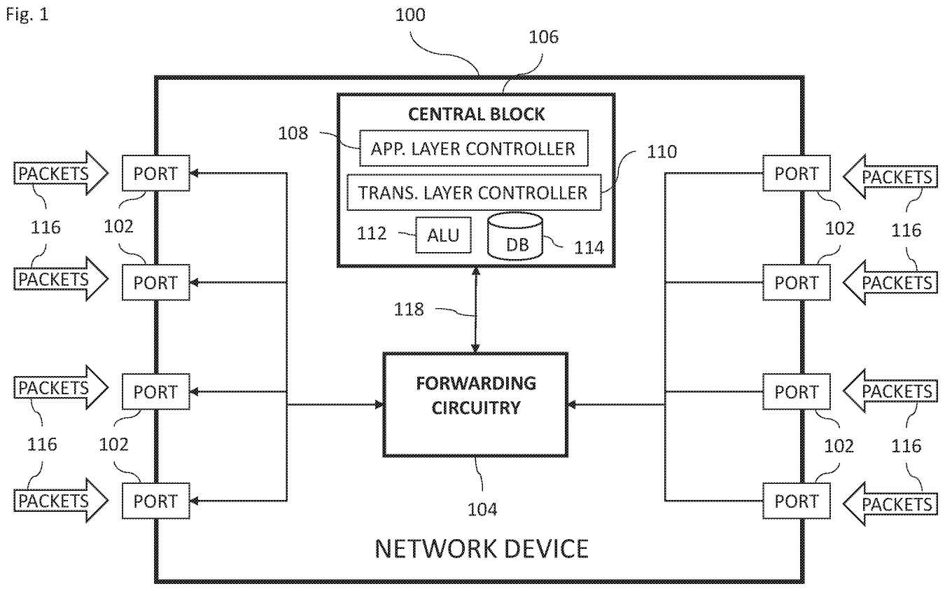

Reference is now made to FIG. 1, which is a block diagram view of a network device 100 implementing data reduction. The network device 100 includes a plurality of ports 102, forwarding circuitry 104, and a central block 106 including an application layer controller 108, a transport layer controller 110, an ALU 112, and a database 114.

The ports 102 are configured as ingress and egress ports for receiving and sending data packets 116, respectively. The received packets 116 are processed by the forwarding circuitry 104 and are either: forwarded to the central block 106, via a single high-speed channel 118, for injecting by the application layer controller 108 into a data reduction process which is performed by the ALU 112; or forwarded to another network node via one of the egress ports. The ALU 112 processes data received by various ports 102 in a serial fashion. The resultant reduced data output by the ALU 112 is packetized by the transport layer controller 110 which manages forwarding the packetized data to at least one network node according to the dictates of an aggregation protocol. The transport layer controller 110 also manages requester and responder handling of the packets associated with the aggregation protocol. It should be noted that the transport layer controller 110 may also manage responder and requester handling for packets received by the network device 100 from a parent node in the aggregation protocol for forwarding to one or more other network nodes in the aggregation protocol. The application layer controller 108 manages at least part of the aggregation protocol (based on at least data included in the packet headers of the received packets for the data reduction process) including selecting which network node(s) (not shown) the packetized data should be sent to. The application layer controller 108, typically based on data included in the packet headers of the received packets for the data reduction process, instructs the ALU 112 how to reduce the data (e.g., which mathematical operation(s) to perform on the data). The database 114 stores data used by the application layer controller 108 and the transport layer controller 110 including data used in requester and responder handling.

Data reduction processing may be performed by any suitable hardware data modifier and embodiments of the present invention are not limited to using an ALU for performing data reduction. In some embodiments, the hardware data modifiers may perform any suitable data modification, including concatenation, by way of example only.

As mentioned above the data reduction process in the network device 100 does not generally provide a throughput according to “wire speed” (WS) unless data is being received via one of the ports 102.

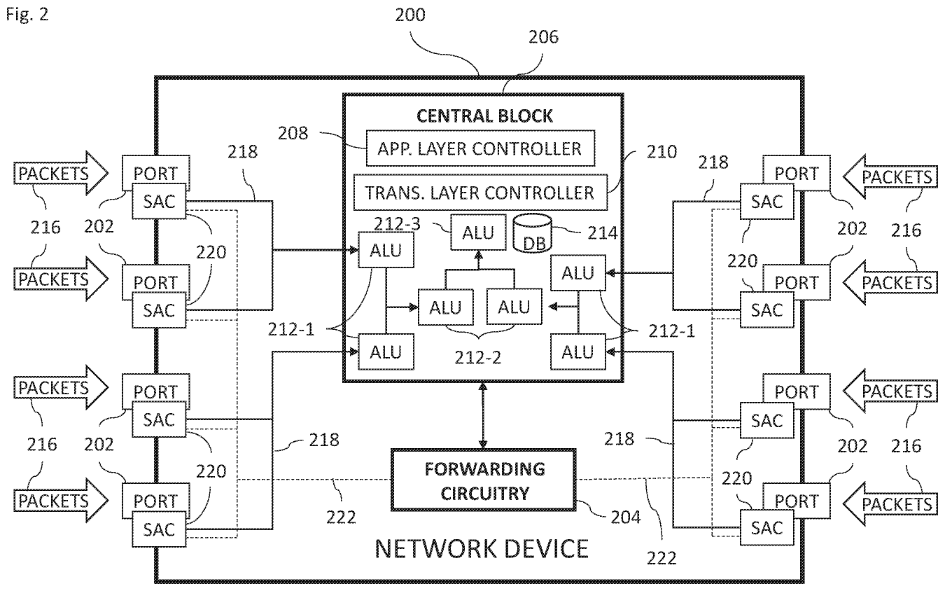

Reference is now made to FIG. 2, which is a block diagram view of a network device 200 implementing data reduction. In this figure and in the figures referenced below similar reference numerals have been used to reference similar elements for the sake of consistency. The network device 200 includes a plurality of ports 202, forwarding circuitry 204, and a central block 206 including an application layer controller 208, a transport layer controller 210, a plurality of ALUs 212, and a database 214. The network device 200 also includes a streaming aggregation circuitry unit 220 associated with each of the ports 202.

The network device 200 of FIG. 2 illustrates how the central block 106 of the network device 100 could be amended in order to achieve WS processing throughput in the data reduction process. However, the design of the network device 200 has some drawbacks discussed below in more detail.

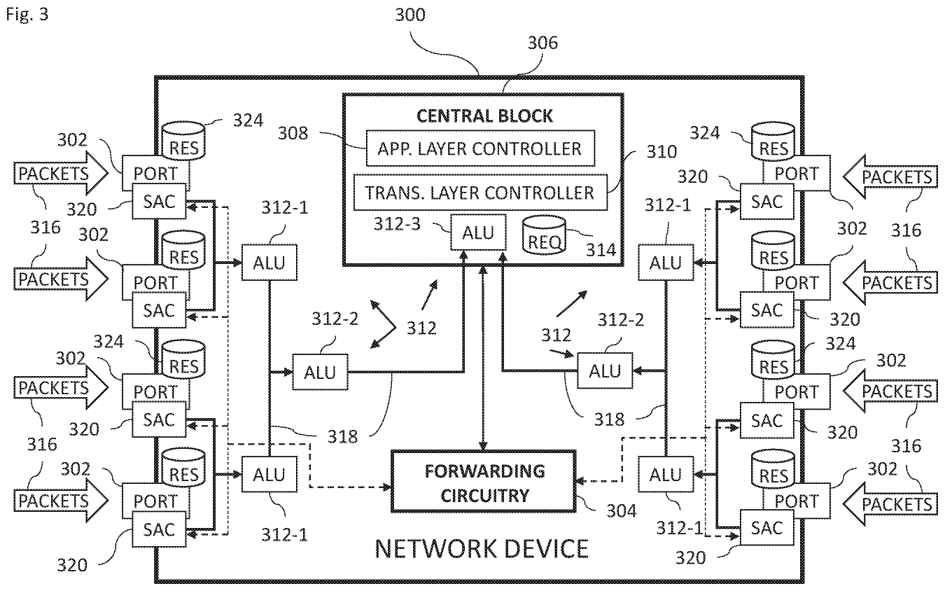

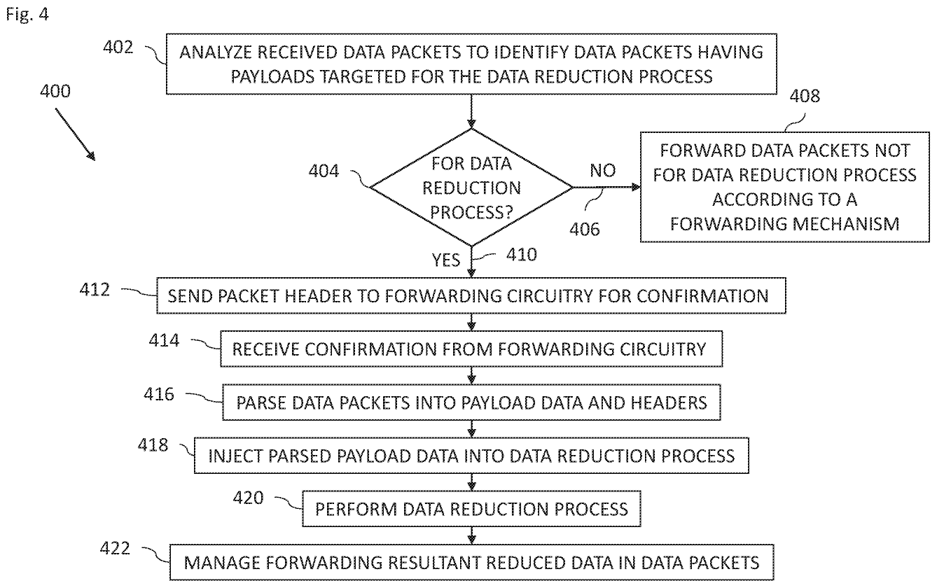

Data packets 216 received by each port 202 are speculatively analyzed by the associated streaming aggregation circuitry unit 220 to determine if packets 216 should be injected in the data reduction process (via high-speed connections 218) or forwarded to another network node via internal connections 222 and the forwarding circuitry 204 and one of the egress ports. The speculative analysis is confirmed by the forwarding circuitry 204 prior to the streaming aggregation circuitry unit 220 parsing the packets 216 and injecting the parsed payload data into the data reduction process. This process is described in more detail with reference to the embodiment of FIGS. 3 and 4.

Each streaming aggregation circuitry unit 220 is connected via a high-speed connection 218 to one of the ALUs 212 in the central block 206. In some embodiments, the functionality of the streaming aggregation circuitry unit 220 is combined with forwarding circuitry 204 and multiple high-speed links may be provided between the forwarding circuitry 204 and the central block 206.

The ALUs 212 are arranged in a hierarchical configuration in the central block 206 so that each ALU 212-1 in a layer closest to the streaming aggregation circuitry units 220 receives the data packets 216 from two of the streaming aggregation circuitry units 220. The ALUs 212-1 reduce data included in the packet payloads. Each ALU 212-2 in a layer adjacent to the ALUs 212-1 receives the reduced data and at least part of the packets 216 (e.g., the packet headers). The ALUs 212-2 further reduce the received reduced data yielding further reduced data. The ALU 212-3 located in a root layer of the hierarchical configuration receives the further reduced data from the ALUs 212-2, and still further reduces the received data yielding a resultant reduced data which is packetized by the transport layer controller 210 for forwarding to one or more network nodes determined by the application layer controller 208.

The network device 200 therefore provides a data reduction process at WS at the cost of the high-speed connection 218 extending from each of the streaming aggregation circuitry units 220 to the central block 206. As discussed above the network device 200 is generally not scalable in terms of chip design and manufacturer, among other drawbacks, due to the high-speed connection 218 extending from the streaming aggregation circuitry units 220 to the central block 206 and the placement of many ALUs 212 in the central block 206.

Reference is now made to FIG. 3, which is a block diagram view of a network device 300 implementing a data reduction process constructed and operative in accordance with an embodiment of the present invention.

The network device 300 includes a plurality of ports 302 (configurable as ingress and egress ports), forwarding circuitry 304, data reduction circuitry 312, a central block 306 including an application layer controller 308, a transport layer controller 310, a central ALU 312-3 (which is part of the data reduction circuitry 312), a requester handling database 314, streaming aggregation circuitry including a plurality of respective streaming aggregation circuitry units 320 connected to, and serving respective ones of the ingress ports. The network device 300 also includes a responder handling database 324 comprised in each port 302. For the sake of simplicity not all of the responder handling databases 324 have been labelled in FIG. 3.

The ports 302 are configured to serve as ingress ports for receiving data packets 316 from a network and as egress ports for forwarding at least some of the data packets 316. Each streaming aggregation circuitry unit 320 is configured to speculatively analyze the received data packets 316 (received on the port 302 associated with that streaming aggregation circuitry unit 320) to identify the data packets 316 having payloads targeted for the data reduction process as part of an aggregation protocol, for example, but not limited to, the “Scalable Hierarchical Aggregation Protocol” (SHArP), described in the abovementioned '613 publication. The streaming aggregation circuitry unit 320 forwards packet headers to the forwarding circuitry 304 as part of a confirmation process whereby the forwarding circuitry 304 confirms that the packets analyzed as being targeted for the data reduction process may be injected into the data reduction process. This is described in more detail with reference to FIG. 4.

Subject to receiving confirmation from the forwarding circuitry 304, each streaming aggregation circuitry unit 320 is configured to parse the identified data packets into payload data and headers and to inject the parsed payload data into the data reduction process.

The streaming aggregation circuitry units 320 are configured to perform responder handling (of the packets 316 associated with the aggregation protocol and packets 316 not associated with the aggregation protocol) whereas requester handling of data packets associated with the aggregation protocol is performed by the transport layer controller 310 described in more detail below.

It should be noted that the transport layer controller 310 in the central block 306 may still manage responder and requester handing for packets received by the network device 300 from a parent node in the aggregation protocol for forwarding to one or more other nodes in the aggregation protocol. The packets received from the patent node are forwarded from the receiving port 302 via the forwarding circuitry 304 to the central block 306 where the transport layer controller 310 manages the responder handling of the received packet. The transport layer controller 310 then manages forwarding and requester handling of the received packet to one or more network nodes according to the aggregation protocol.

Packet headers of the packets 316 targeted for the data reduction process may also include data needed by the application layer controller 308 for managing the aggregation protocol, such as which operation(s) (e.g., mathematical operation(s)) the ALUs 312 should perform and where resultant reduced data should be sent. Therefore, at least one packet (e.g., a first packet in a message) of the packets 316 targeted for the data reduction process is forwarded to the central block 306 via the forwarding circuitry 304 for receipt by the application layer controller 308.

Therefore, the responder handling and the requester handling of data packets targeted for the data reduction process of the aggregation protocol are split between the streaming aggregation circuitry units 320 and the central block 306 (in which the transport layer controller 310 is disposed), respectively. The split also manifests itself with respect to data storage with the responder handling database 324 of each port 302 storing data used in the responder handling, and the requester handling database 314 disposed in the central block 306 storing data used in the requester handling as well as other data used by the application layer controller 308 and the transport layer controller 310. Splitting the responder and requester handling between the streaming aggregation circuitry unit 320 and the central block 306 also leads to less data being injected to the data reduction circuitry 312 as only data needed for data reduction needs to be injected into the data reduction circuitry.

The data reduction circuitry 312 is connected to the ingress ports via the streaming aggregation circuitry units 320 and is configured to perform the data reduction process on the parsed payload data. The data reduction circuitry 312 includes a multiplicity of ALUs including the central ALU 312-3 and non-central ALUs 312-1, 312-2. The ALUs are connected and arranged to reduce the parsed payload data in stages with a last stage of the data reduction process in the network device 300 being performed by the central ALU 312-3. The central ALU 312-3 is configured to receive data from the non-central ALUs 312-2 and to output resultant reduced data. In the example, of FIG. 3 the central ALU 312-3 receives input from two non-central ALUs 312-2. In some embodiments, the central ALU 312-3 may receive input from more than two non-central ALUs 312-2.

In the embodiment of FIG. 3, the non-central ALUs 312-1, 312-2 are disposed externally to the central block 306 so that there are only two respective high-speed input channels 318 into the central block 306 to the central ALU 312-3 from two respective ones of the non-central ALUs 312-2. Disposing the non-central ALUs externally to the central block 306 leads to shorter overall high-speed channels 318 even though generally the network device 300 has the same amount of ALUs as the network device 200 of FIG. 2. The design of network device 300 not only shortens the overall length of the high-speed channels but reduces the number of interfaces to central block 306 and is generally more scalable.

In some embodiments, the central block 306 may include more than one ALU with more than two input channels 318 entering the central block 306.

The example of FIG. 3, shows the ALUs arranged in a hierarchical configuration including a root level, a leaf level and an intermediate level. Each non-central ALU 312-1 in the leaf level is configured to receive data from at least two of the ingress ports and to output data to one of the non-central ALUs 312-2 in the intermediate level. The central ALU 312-3 is disposed in the root level, and is configured to receive data from the non-central ALUs 312-2 in the intermediate level. The number of ingress ports connected to, and providing data to, one ALU 312-1 may depend on the processing capabilities and bandwidth properties of the ALU 312-1. The number of levels in the hierarchical configuration depends on the number of ports 302 included in the network device 300 so that in some implementations the network device 300 may include multiple intermediate levels, in which an ALU in an intermediate level closer to the leaf level may output data to an adjacent intermediate level closer to the root level, and so on, until all the intermediate levels are traversed by the data that is input into the data reduction process.

The application layer controller 308 is configured to: control at least part of the aggregation protocol among network nodes in the network; manage operation(s) (e.g., mathematical operation(s)) performed by the ALUs; and select at least one network node (e.g., according to the aggregation protocol) to which to forward the resultant reduced data output by the central ALU 312-3.

The transport layer controller 310 is configured to: manage forwarding of the resultant reduced data in data packets to the network node(s) (selected by the application layer controller 308) via at least one of the egress ports; and perform requester handling of the data packets that include the resultant reduced data.

Any suitable method may be used to distribute the data packets that include the resultant reduced data to the selected network node(s), for example, but not limited to, a distribution method described in US Patent Publication 2018/0287928 of Levi, et al., which is herein incorporated by reference.

In practice, some or all of the functions of the transport layer controller 310 and the application layer controller 308 may be combined in a single physical component or, alternatively, implemented using multiple physical components. These physical components may comprise hard-wired or programmable devices, or a combination of the two. In some embodiments, at least some of the functions may be carried out by a programmable processor under the control of suitable software. This software may be downloaded to a device in electronic form, over a network, for example. Alternatively, or additionally, the software may be stored in tangible, non-transitory computer-readable storage media, such as optical, magnetic, or electronic memory.

The network device 300 may include other standard components included in a network device but have been not been included in the present disclosure for the sake of simplicity.

Reference is now made to FIG. 4, which is a flowchart 400 including exemplary steps in a method of operation of the network device 300 of FIG. 3. Reference is also made to FIG. 3.

The streaming aggregation circuitry comprising the streaming aggregation circuitry units 320 is configured to inspect (block 402) the received data packets 316 to speculatively analyze the data packets to identify data packets having payloads targeted for the data reduction process as part of the aggregation protocol. The speculative analysis may include inspecting packet header information including source and destination information as well as other header information such as layer 4 data. At a decision block 404, the streaming aggregation circuitry determines whether ones of the packets 316 are potentially for the data reduction process (branch 410) or not for the data reduction process (branch 406). The packets 316 which are not targeted for the data reduction process (including packets from a parent node of the aggregation process and destined for the central block 306) are forwarded (block 408) according to a forwarding mechanism to one or more network nodes (which may include forwarding to the central block 306) according to the destination addresses of the packets 316. For example, the packets 316 may be forwarded by the streaming aggregation circuitry units 320 to the forwarding circuitry 304 for forwarding to one or more network nodes via one or more of the egress ports.

The streaming aggregation circuitry is configured to send (block 412) packet headers of data packets having payloads potentially targeted for the data reduction process as part of the aggregation protocol to the forwarding circuitry 304. The forwarding circuitry 304 is configured to analyze the packet headers (using layer 2 and 3 information such as source and destination information) in order to determine whether the speculative analysis of the streaming aggregation circuitry was correct. The forwarding circuitry 304 is configured to send a confirmation approving the speculative analysis to the streaming aggregation circuitry which receives (block 414) the decision. If the forwarding circuitry 304 determines that the speculative analysis of the streaming aggregation circuitry of a given packet(s) is incorrect, the streaming aggregation circuitry unit does not forward payload data of the given packet(s) to the data reduction path but instead forwards the given packet(s) via the standard forwarding mechanism of the network device 300.

The streaming aggregation circuitry is configured to parse (block 416) the data packets 316 confirmed as being targeted for the data reduction process into payload data and headers. The streaming aggregation circuitry is configured to inject (block 418) the parsed payload data into the data reduction process executed by the ALUs 312, which perform (block 420) the data reduction process yielding the resultant reduced data. The transport layer controller 310 is configured to manage (block 422) forwarding the resultant reduced data in data packets.

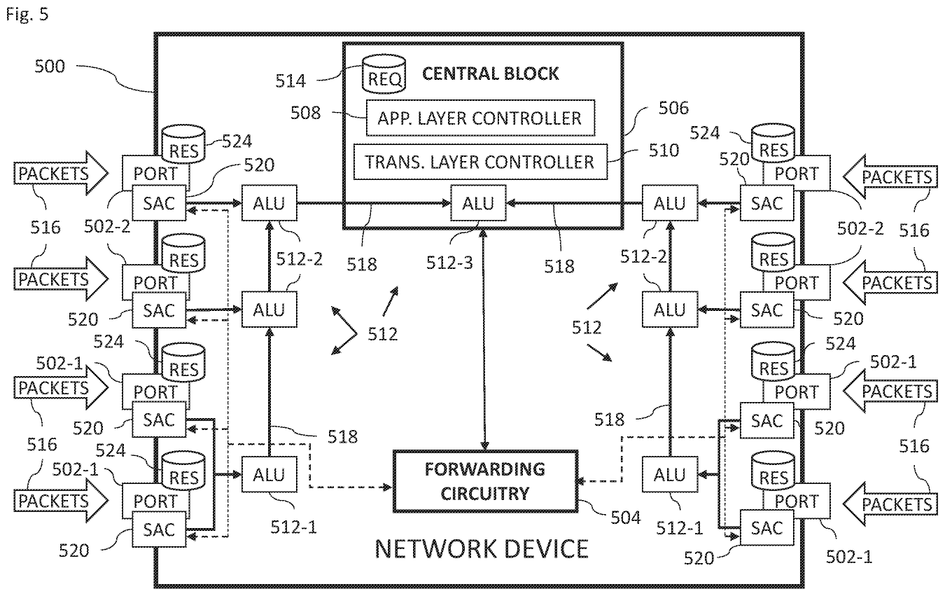

Reference is now made to FIG. 5, which is a block diagram view of a network device 500 implementing a data reduction process constructed and operative in accordance with an alternative embodiment of the present invention.

The network device 500 is substantially the same as the network device 300 of FIG. 3 except that the ALUs of data reduction circuitry 512 of the network device 500 is arranged in a daisy-chain configuration described in more detail below. The network device 500 includes a plurality of ports 502, forwarding circuitry 504, a central block 506 including an application layer controller 508, a transport layer controller 510, a central ALU 512-3, and a requester handling database 514. The network device 500 also includes high speed connections 518 between the ports 502 and the data reduction circuitry 512 all the way to the central ALU 512-3. The network device 500 also includes streaming aggregation circuitry comprising a plurality of respective streaming aggregation circuitry units 520 associated with respective ones of the ports 502, and a responder handling database 524 included in each port 502.

The daisy-chain configuration includes at least two end nodes converging via intermediates nodes on a central node, as will now be described in more detail. The ALUs 512 are connected in a chain formation extending from two sides to the central ALU 512-3, namely, from ALUs 512-1 via ALUs 512-2 to the central ALU 512-3.

Each end node includes one of the non-central ALUs 512-1 configured to receive data from at least one ingress port 502-1 (FIG. 5 shows the ALUs 512-1 each receiving input from two ingress ports 502-1) and to output data to one of the non-central ALUs 512-2 (next in the chain) disposed in one of the intermediate nodes.

Each intermediate node includes one of the non-central ALUs 512-2 configured to receive data from at least one of the ingress ports 502-2 and one of the non-central ALUs 512-1 or one of the ALUs 512-2.

The central node includes the central ALU 512-3 which is configured to receive data from at least two non-central ALUs (two ALUs 512-2 in FIG. 5) of the intermediate nodes.

An ALU 512 in the daisy-chain configuration may receive input from one, two, or more ports 502 depending on the processing speed of the ALU 512 and the design requirements.

The daisy-chain configuration generally does not require additional hierarchical layers of ALUs when new ports are added to the network device design as compare to the hierarchical configuration. In the daisy-chain configuration each additional port generally adds a new streaming aggregation circuitry unit 520, a responder handling database 524 and an ALU 512-1 (which may be shared with other ports). The daisy chain configuration generally results in shorter high-speed connections 518 across the chip implementing the network device 500 and is generally more scalable than the design used in the network device 300.

Various features of the invention which are, for clarity, described in the contexts of separate embodiments may also be provided in combination in a single embodiment. Conversely, various features of the invention which are, for brevity, described in the context of a single embodiment may also be provided separately or in any suitable sub-combination.

The embodiments described above are cited by way of example, and the present invention is not limited by what has been particularly shown and described hereinabove. Rather the scope of the invention includes both combinations and subcombinations of the various features described hereinabove, as well as variations and modifications thereof which would occur to persons skilled in the art upon reading the foregoing description and which are not disclosed in the prior art.

What is claimed is:

1. A network device, comprising:
a plurality of ports configured to serve as ingress ports for receiving data packets from a network and as egress ports for forwarding at least some of the data packets;
streaming aggregation circuitry connected to the ingress ports, and configured to:
analyze the received data packets to identify ones of the data packets having payloads targeted for a data reduction process;
parse at least some of the identified data packets into payload data and headers; and
inject the parsed payload data into the data reduction process;
data reduction circuitry connected to the ingress ports and configured to perform the data reduction process on the parsed payload data, and comprising a multiplicity of hardware data modifiers (HMDs) including a central HDM and non-central HDMs, the HDMs being connected and arranged to reduce the parsed payload data in stages with a stage of the data reduction process in the network device being performed by the central HDM which is configured to receive data from at least two of the non-central HDMs and to output resultant reduced data; and
a transport layer controller configured to manage forwarding of the resultant reduced data in data packets to at least one network node via at least one of the egress ports.

2. The device according to claim 1, wherein:
at least some of the HDMs are arranged in a hierarchical configuration including a root level, a leaf level and at one intermediate level;
each one of the non-central HDMs in the leaf level is configured to receive data from at least two of the ingress ports and to output data to one of the non-central HDMs in the at least one intermediate level; and
the central HDM is disposed in the root level, and is configured to receive data from the at least two non-central HDMs in the at least one intermediate level.

3. The device according to claim 1, wherein the HDMs are arranged in a daisy-chain configuration comprising at least two end nodes converging via intermediates nodes on a central node, wherein:
each one of the at least two end nodes includes one of the non-central HDMs configured to receive data from at least one of the ingress ports and to output data to one of the non-central HDMs disposed in one of the intermediate nodes;
each one of the intermediate nodes includes one of the non-central HDMs configured to receive data from at least one of the ingress ports and one of the non-central HDMs; and
the central node includes the central HDM which is configured to receive data from the at least two non-central HDMs of the intermediate nodes.

4. The device according to claim 1, further comprising a central block including:
the central HDM;
an application layer controller configured to: control at least part of an aggregation protocol among network nodes in the network; select the at least one network node to which to forward the resultant reduced data output by the central HDM; and manage operations performed by the HDMs;
the transport layer controller which is also configured to perform requester handling of the data packets including the resultant reduced data; and
a requester handling database to store data used in the requester handling.

5. The device according to claim 4, further comprising two respective input channels into the central block to the central HDM from two respective ones of the non-central HDMs, the non-central HDMs being disposed externally to the central block.

6. The device according to claim 4, wherein the streaming aggregation circuitry is configured to perform responder handling, so as to split the responder handling and the requester handling of data packets of targeted for the data reduction process of the aggregation protocol between the streaming aggregation circuitry and the central block, respectively, each of the ingress ports further comprising a responder handling database to store data used in the responder handling.

7. The device according to claim 6, wherein:
at least some of the HDMs are arranged in a hierarchical configuration including a root level, a leaf level and at one intermediate level;
each one of the non-central HDMs in the leaf level is configured to receive data from at least two of the ingress ports and to output data to one of the non-central HDMs in the at least one intermediate level; and
the central HDM is disposed in the root level, and is configured to receive data from the at least two non-central HDMs in the at least one intermediate level.

8. The device according to claim 6, wherein the HDMs are arranged in a daisy-chain configuration comprising at least two end nodes converging via intermediates nodes on a central node, wherein:
each one of the at least two end nodes includes one of the non-central HDMs configured to receive data from at least one of the ingress ports and to output data to one of the non-central HDMs disposed in one of the intermediate nodes;
each one of the intermediate nodes includes one of the non-central HDMs configured to receive data from at least one of the ingress ports and one of the non-central HDMs; and
the central node includes the central HDM which is configured to receive data from the at least two non-central HDMs of the intermediate nodes.

9. The device according to claim 1, wherein the streaming aggregation circuitry includes a plurality of respective streaming aggregation circuitry units connected to, and serving respective ones of the ingress ports.

10. The device according to claim 1, wherein the data reduction process is part of an aggregation protocol.

11. A data reduction method, comprising:
receiving data packets in a network device from a network;
forwarding at least some of the data packets;
analyzing the received data packets to identify ones of the data packets having payloads targeted for a data reduction;
parsing at least some of the identified data packets into payload data and headers;
injecting the parsed payload data into the data reduction process;
performing the data reduction process on the parsed payload data using data reduction circuitry comprising a multiplicity of hardware data modifiers (HDMs) including a central HDM and non-central HDMs, the HDMs being connected and arranged to reduce the parsed payload data in stages with a stage of the data reduction process in the network device being performed by the central HDM outputting resultant reduced data; and
managing forwarding of the resultant reduced data in data packets to at least one network node.

12. The method according to claim 11, wherein at least some of the HDMs are arranged in a hierarchical configuration including a root level, a leaf level and at one intermediate level; the method further comprising:
receiving data from at least two ingress ports and outputting data to one of the non-central HDMs in the at least one intermediate level by one of the non-central HDMs in the leaf level; and
receiving data from at least two non-central HDMs in the at least one intermediate level by the central HDM which is disposed in the root level.

13. The method according to claim 11, wherein the HDMs are arranged in a daisy-chain configuration comprising at least two end nodes converging via intermediates nodes on a central node, the method further comprising:
receiving data from at least one ingress port and outputting data to one of the non-central HDMs disposed in one of the intermediate nodes by one of non-central HDMs disposed in one of the at least two end nodes;
receiving data from at least one ingress port and from one of the non-central HDMs by one of the non-central HDMs disposed in one of the intermediate nodes; and
receiving data from at least two of the non-central HDMs of the intermediate nodes by the central HDM disposed in the central node.

14. The method according to claim 11, further comprising:
controlling at least part of an aggregation protocol among network nodes in the network;
selecting the at least one network node to which to forward the resultant reduced data output by the central HDM;
managing operations performed by the HDMs;
performing requester handling of the data packets including the resultant reduced data; and
storing data used in the requester handling.

15. The method according to claim 14, further comprising:
performing responder handling by streaming aggregation circuitry, so as to split the responder handling and the requester handling of data packets targeted for the data reduction process of the aggregation protocol between the streaming aggregation circuitry and a central block comprising the central HDM, respectively; and
storing data used in the responder handling.

16. The method according to claim 15, wherein at least some of the HDMs are arranged in a hierarchical configuration including a root level, a leaf level and at one intermediate level; the method further comprising:
receiving data from at least two ingress ports and outputting data to one of the non-central HDMs in the at least one intermediate level by one of the non-central HDMs in the leaf level; and
receiving data from at least two non-central HDMs in the at least one intermediate level by the central HDM which is disposed in the root level.

17. The method according to claim 15, wherein the HDMs are arranged in a daisy-chain configuration comprising at least two end nodes converging via intermediates nodes on a central node, the method further comprising:
receiving data from at least one ingress port and outputting data to one of the non-central HDMs disposed in one of the intermediate nodes by one of non-central HDMs disposed in one of the at least two end nodes;
receiving data from at least one ingress port and from one of the non-central HDMs by one of the non-central HDMs disposed in one of the intermediate nodes; and
receiving data from at least two of the non-central HDMs of the intermediate nodes by the central HDM disposed in the central node.

18. The method according to claim 11, wherein the data reduction process is part of an aggregation protocol.
